(19) United States
(12) Patent Application Publication
(10) Pub. No.: US 2005/0154784 A1
(43) Pub. Date: Jul. 14, 2005

(54) Providing a shared storage space in association with a telephone call

(75) Inventors: Jerry W. Malcolm, Austin, TX (US); Cornell G. Wright JR., Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/756,129

(22) Filed: Jan. 13, 2004

(51) Int. Cl. G06F 15/167; G06F 15/173

(52) U.S. Cl. 709/213; 709/225

(57) ABSTRACT

A method and apparatus is provided for providing a shared storage space in association with a telephone call. The method comprises receiving information associated with a telephone call involving a first party and a second party and allocating a storage space that is accessible by at least one of the first party and the second party based on at least a portion of the received information. The method further comprises allowing at least one of the first party and second party to provide electronic information intended for the other party using the storage space.

### BACKGROUND OF THE INVENTION

1. Field of the Invention

The invention generally relates to a communications system, and, in particular, to providing a shared storage space to parties participating in a telephone call in the communications system.

2. Description of the Related Art

For years, telephones have been a reliable way of communicating with remotely located parties. Even today, business and non-business entities rely on telephones, be it cordless telephones, wired telephones, cellular telephones, to conduct day-to-day operations. However, oftentimes during a telephone conversation, a need arises to exchange non-verbal or electronic information, such as business card information, text documents, photos, drawings, video files, audio files, multimedia files, and the like. The conventional telephones, unfortunately, do not provide users with the capability of exchanging non-verbal or electronic data.

To exchange electronic information over a telephone line or connection, users on each side must typically be equipped with special equipment that provides such capability. This approach is undesirable because it requires the calling party or called party to purchase additional equipment and/or an additional telephone line for the specific purpose of exchanging non-verbal or electronic information. Moreover, this approach may require the parties to make a coordinated purchase to ensure that the equipment on both sides is compatible. In some instances, such equipment can prove to be expensive and can tend to have limited alternative uses other than for its intended purpose.

With the emerging popularity of the Internet, a few tools or utilities have now been developed that allow users to exchange documents. One example of such a tool is NetMeeting® by Microsoft® Corporation. These tools, however, commonly require the communicating parties to first exchange meeting identifiers by e-mail or voice before the documents can be exchanged. This can not only be inefficient but also inconvenient to the communicating parties.

The present invention is directed to addressing, or at least reducing, the effects of, one or more of the problems set forth above.

### SUMMARY OF THE INVENTION

In one aspect of the instant invention, a method is provided for providing a shared storage space in association with a telephone call. The method comprises receiving information associated with a telephone call involving a first party and a second party and allocating a storage space that is accessible by at least one of the first party and the second party based on at least a portion of the received information. The method further comprises allowing at least one of the first party and the second party to provide electronic information intended for the other party using the storage space.

In another aspect of the instant invention, an apparatus is provided for providing a shared storage space in association with a telephone call. The apparatus comprises a storage unit communicatively coupled to a control unit. The control unit is adapted to receive information associated with a telephone call involving a first party and a second party and allocate a storage space in the storage unit that is accessible by at least one of the first party and the second party based on at least a portion of the received information. The apparatus further comprises allowing at least the first party to provide electronic information intended for the second party using the storage space.

In yet another aspect of the instant invention, an article comprising one or more machine-readable storage media containing instructions is provided for providing a shared storage space in association with a telephone call. The instructions, when executed, enable a processor to receive information associated with a telephone call involving a first party and a second party and allocate a storage space that is accessible by at least one of the first party and the second party based on at least a portion of the received information. The instructions, when executed, further enable the processor to allow at least the first party to provide electronic information intended for the second party using the storage space.

In yet another aspect of the instant invention, a system is provided for providing a shared storage space in association with a telephone call. The system comprises a first processor-based device communicatively coupled to a second processor-based device. The second processor-based device is adapted to receive information associated with a telephone call involving a first party and a second party and allocate a storage space that is accessible by at least one of the first party and the second party based on at least a portion of the received information. The system further comprises allowing at least the first party to at least one of provide and receive electronic information using the first-processor device to and from the storage space.

In yet another aspect of the instant invention, a method is provided for providing a shared storage space in association with a telephone call. The method comprises accessing a storage space that is allocated based on information associated with a telephone call involving a first party and a second party, wherein the storage space is accessible to at least the first party and second party and accessing electronic information from the storage space, wherein the electronic information is provided by at least one of the first party and second party.

### BRIEF DESCRIPTION OF THE DRAWINGS

The invention may be understood by reference to the following description taken in conjunction with the accompanying drawings, in which like reference numerals identify like elements.

FIG. 1 is a block diagram of an embodiment of a communications system including a module for providing a shared storage space for one or more call participants, in accordance with the present invention.

FIG. 2 depicts a flow diagram of at least one aspect of the module of FIG. 1, in accordance with one embodiment of the present invention.

FIG. 3 illustrates an exemplary web browser window allowing a caller to access the shared storage space, in accordance with one embodiment of the present invention.

FIG. 4 depicts a block diagram of a processor-based system that may be implemented in the communications system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, and as is described in greater detail below, in accordance with one or more embodiments of the present invention, parties participating in a telephone call can readily exchange documents via a shared storage space, such as a Web space on the Internet. In one embodiment, the shared storage space is created or allocated based on information collected from the call that is placed by the calling party. The information may, for example, include the name or telephone number of the calling party, as well as the name(s) and number(s) of the called party or parties (in the case of a teleconference call). Once the shared storage space for the communicating parties is established, each party may share electronic data, in the form of documents or files, with others call participants. Other features of the invention are described below.

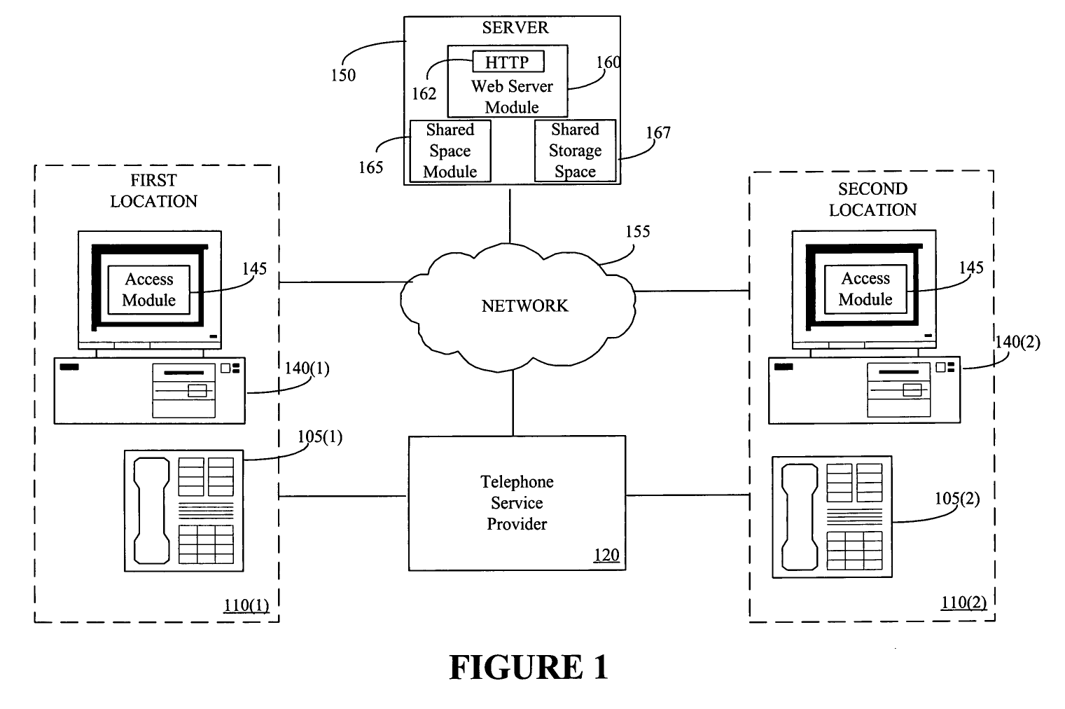

Referring to FIG. 1, a communications system 100 is illustrated in accordance with one embodiment of the present invention. The communications system 100 of FIG. 1 includes a first telephone 105(1) located at a first location 110(1) and a second telephone 105(2) located at a second location 110(2). Through conventional, well-known techniques, users situated at the first and second locations 110(1-2) can establish a voice connection using their respective telephones 105(1-2) through a telephone service provider 120. The voice connection may be established, for example, through a Public Switched Telephone Network (not shown).

The telephones 150(1-2) may be any variety of telephones, including those that are publicly available. The telephones 150(1-2) may be, for example, wired telephones, cordless telephones, and/or cellular telephones. In one embodiment, the telephone 150(1-2) may be a voice over Internet Protocol (VoIP) telephone. Although in the illustrated embodiment the telephones 150(1-2) are illustrated as standalone devices, it should be appreciated that the present invention is not limited as such. In alternative embodiments, the “telephone” feature may be integrated into other electronic devices, such as personal digital assistants or computers. For example, in one embodiment, a computer or another processor-based device may be configured with the appropriate software to provide a capability of a telephone (e.g., a user may utilize a microphone and speaker(s) associated with an appropriately configured computer to transmit and receive speech signals over a telephone line or network connection). Such telephone implementations are considered to be within the spirit and scope of the present invention.

In accordance with one embodiment of the present invention, the communications system 100 includes a processor-based device 140(1) associated with a user of first telephone 105(1) and a processor-based device 140(2) associated with a user of the second telephone 105(2). The processor-based devices 140(1-2) may include computers (e.g., desktops, laptops, mainframes), portable electronic devices, Internet appliances, and the like.

The processor-based devices 140(1-2) may each include an access module 145 that allows various telephone call participants to access their respective shared space through a server 150 via a network 155, such as by a private network or a public network (e.g., the Internet). Although not so limited, for ease of illustration, it is herein assumed that the network 155 is a public network, such as the Internet. In one embodiment, the various devices 140(1-2) and server 150 may be coupled to the network 155 through a router (not shown), gateway (not shown), or by other intervening, suitable devices.

In the illustrated embodiment, the access module 145 is a web browser application, such as Netscape® or Internet Explorer®, although, in alternative embodiments, other suitable application(s) may also be employed without deviating from the spirit and scope of the present invention. In one embodiment, the access module 145 may include other modules, such as an applet, that allows call participants to store (or upload) electronic documents to the shared space with other call participants, as discussed later.

The server 150 of FIG. 1 in the illustrated embodiment includes a web server module 160 and a shared space module 165. The web server module 160, for example, may include an HTTP (Hypertext Transfer Protocol) service routine 162 that is capable of receiving HTTP requests over the network 155, as well as sending HTTP responses over the network 155. The requests may, for example, be received from clients such as the processor-based devices 140(1-2). HTTP specifies how a client and server 150 may establish a connection, how the client may request data from the server 150, how the server 150 may respond to the request, and how the connection may be closed. One version of HTTP is described in RFC 2068, entitled “Hypertext Transfer Protocol-HTTP/1.1,” dated January 1997. In an alternative embodiment, the HTTP over Secure Socket Layer (HTTPS) protocol may also be employed.

The shared space module 165, in one embodiment, creates or allocates a shared storage space 167 that is accessible by the various parties participating in a telephone call (or in a teleconference). The shared space 167 need not be resident within the server 150; in alternative embodiments, the shared space 167 may be located on a standalone storage drive (not shown) that is communicatively coupled to, and thus accessible by, the server 150.

In one embodiment, access to the shared space 167 may be granted only to authorized participants, which may be determined beforehand or dynamically, depending on the implementation. Once the shared space 167 is established, the call participants can exchange electronic information with each other in the form of text documents, multimedia files, graphics file, audio files, and the like, using the shared storage space 167. The manner in which the shared space can be created so that each party or parties can thereafter access it is a matter of design choice, and can be created by those skilled in the art having the benefit of this disclosure. For example, in one embodiment, the shared space module 165 may create directories from a common file system pool, and then set up pointers to each “call folder,” one in the callee's web page and one in the caller's web page. In the case of a conference call, pointers to the shared space may be provided in the webpage of each participant.

It should be appreciated that while a single shared space module 165 is depicted in FIG. 1, that in alternative embodiments, the shared space module 165 may comprise a plurality of modules, with each module capable of providing one or more of the desired features. For example, the module 165 may include a module for determining information associated with the calling party and called party. This information may be used to create a shared storage space 167 for the communicating parties to exchange various types of electronic information. As another example, the shared space module 165 may include a module for authenticating the parties before allowing access to the shared storage space 167. As yet another example, the module 165 may include a module for creating and managing the shared storage space 167.

The modules 145, 160, and 165 illustrated in FIG. 1 are implemented in software, although in other implementations it may also be implemented in hardware or a combination of hardware and software. The server 150, in one embodiment, may be a processor-based device that is configured with the appropriate software module(s) to perform one or more operations associated with the server 150.

The network 155 of FIG. 1 may be a packet-switched data network, such as a data network according to the Internet Protocol. Examples of the network 155 may include local area networks (LANs), wide area networks (WANs), intranets, and, as noted, the Internet. One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 155 may also include other types of packet-based data networks in further embodiments. Examples of such other packet-based data networks include Asynchronous Transfer Mode (ATM), Frame Relay networks and the like.

As utilized herein, a “network” may refer to one or more communication networks, channels, links, or paths, and systems or devices (such as routers) used to route data over such networks, channels, links, or paths.

It should be understood that the configuration of the communications system 100 of FIG. 1 is exemplary in nature, and that fewer, additional, or different components may be employed in other embodiments of the communications system 100. For example, while the communications system 100 in the illustrated example includes one server 150, in other embodiments, additional servers may be employed, where the various servers may be communicatively coupled to each other by the network 155. The location of the server 150 can also be implementation specific. For example, in one embodiment, the server 150 may be located at and maintained by the service provider 120. Additionally, in one embodiment, various portions of the shared space module 165 may be distributed across a plurality of servers, where each portion may perform a desired operation. Additionally, although the processor-based devices 140(1-2) and the telephones 105(1-2) at each location 110 are depicted as separate devices, it should be noted that in an alternative embodiment, the processor-based device 140 and the telephone 105 may be integrated into one device, such as a telephone that also has capabilities of interfacing the network 155 or a computer that has telephonic capabilities. Similarly, other configurations may be employed in the communications system 100 without deviating from the spirit and scope of the invention.

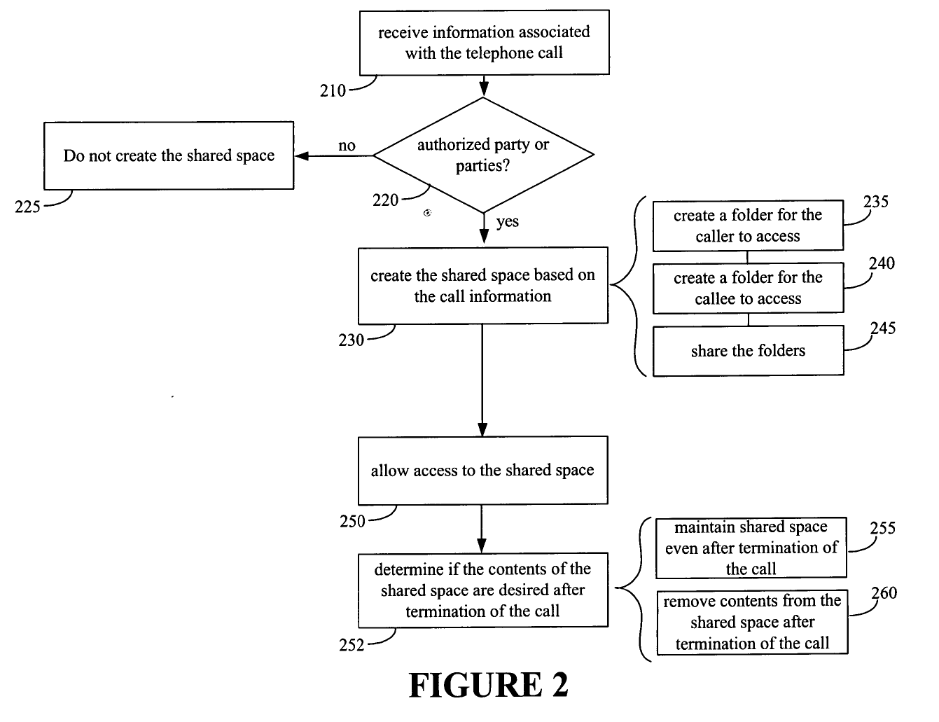

FIG. 2 illustrates a flow diagram illustrating at least one operation performed by the shared space module 165 of FIG. 1 to allow various parties participating in a telephone call to share electronic information, in accordance with one embodiment of the present invention. For ease of illustration, in describing the method of FIG. 2, it is herein assumed that a call is placed from the first location 110(1) to the second location 110(2). As such, in the illustrated example, the user at the first location 110(1) is the “caller” or “calling party,” and the user at the second location 110(2) is the “callee” or “called party.” It should be noted that while the illustrated example describes a call between only two parties, the present invention is not limited as such, and can be applicable to teleconference calls involving two or more parties.

Referring to FIG. 2, once the call is initiated by caller, the shared space module 165 receives (at 210) information associated with a telephone call (e.g., caller and callee information). In one embodiment, the processing of the call (e.g., establishing a connection between the parties) may occur substantially independent of the server 150. As such, as the server 150 receives (at 210) the call information, a connection may be in the process of being established or may have already been established between the parties.

The call information received (at 210) may include, but is not limited to, one or more of the following: name of the calling party, telephone number of the calling party, name of the called party, telephone number of the called party, time of the call, and date of the call. In one embodiment, this information may be provided to the server 150 by the telephone service provider 120. That is, in one embodiment, using existing services already provided by several telecommunications service providers 120, or using other well-known technologies, the server 150 can be notified about calls that are placed to and from the telephone number associated with a given telephone 105. In this instant, the server 150 may be provided information about calls that are placed to and from the first telephone 105(1). Similarly, if desired, the service provider 120 may also provide information to the server 150 about calls made to and from the second telephone number 105(2). In one embodiment, the information about the calling parting and the called party may be provided over the network 155 using the Internet Protocol.

In an alternative embodiment, instead of the service provider 120 providing the telephone call information, the server 150 may itself monitor calls placed to and from a particular telephone 105 to access the desired information. For example, the call information may be obtained from caller ID information that is associated with a given telephone call. In other embodiments, other suitable ways of providing the caller/callee information to the server 150 may also be employed without deviating from the spirit and scope of the invention.

In one embodiment, the shared space module 165, based on the received information (at 210), determines (at 220) if the call participants are authorized users. A call participant may not be “authorized” for a variety of reasons. For example, in one embodiment, the “shared storage space” feature may be provided as a “premium” service, and only those users that are subscribers may be “authorized” to use this service. Thus, in such a scenario, if it is determined (at 220) that one or more of the call participants are not subscribers, and thus not authorized, the module 165 does not create (at 225) the shared storage space for the unauthorized party or parties. Even though a shared space is not created for the unauthorized parties, in one embodiment, the call may nevertheless be allowed to complete. This means that while the call participants may establish a connection, they would not have access to the shared storage space 167 to exchange electronic data. In one embodiment, a call participant may also not be “authorized” if that call participant is blacklisted (i.e., a system administrator may create a “blacklist” to prevent selected callers or callees from having access to the “shared storage space” feature). In one embodiment, the blacklist may be maintained by the service provider 120 and provided to the server 150.

It is noted that the feature of allowing only “authorized” call participants to access the “shared storage space” is a matter of design choice. In an alterative embodiment, the shared space module 165 may not perform an authorization check (at 220), and, instead, may grant access to any and all call participants. Again, the manner in which a user's access is limited to the shared access space, if it is limited at all, is a matter of design choice, and can vary from one implementation to another.

In FIG. 2, the module 165 creates (at 230) the shared storage space 167 based on the received call information. In one embodiment, creating the shared storage space 167 (at 230) may comprise creating (at 235) an electronic folder for the caller to access, creating (at 240) a folder for the callee to access, and sharing (at 245) the created folders. The act of sharing (at 245) the folders may include cross-linking the folders such that items placed in one folder by a call participant can be mirrored into the folders of the other call participants. Thus, in one embodiment, the shared space module 165 creates a copy of a folder for each call participant to manage. In an alternative embodiment, a common folder may be created for the various call participants, such that any of the call participants can add or remove electronic information from that common folder. In one embodiment, the shared space module 165 may create a folder for the calling party even if the call is not answered by the party at the other end. In this manner, the calling party may transfer the desired documents to the shared space 167 even if the called party does not answer. The called party may thereafter access the caller's documents from the shared space 167 at a later time.

Referring again to FIG. 2, the shared space module 165 allows (at 250) the call participants to access the shared storage space 167 that was previously created (at 230). In one embodiment, the call participants may access the shared storage space 167 using their respective access module 145. For example, as the caller and callee engage in a phone conversation, each may use the access module 145 to access the shared storage space 167 on the server 150 by entering, for example, the appropriate universal resource locator (URL). If the network 155 is a data network other than the Internet, then the call participants may enter the appropriate location path for that particular data network to access the shared storage space 167.

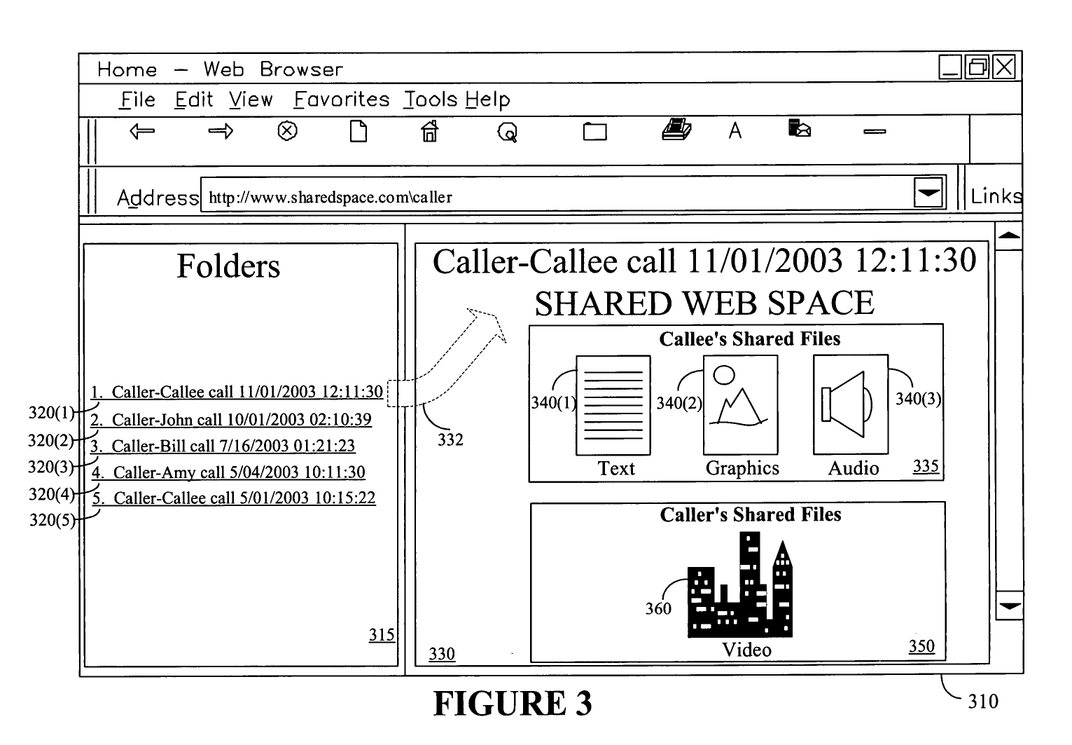

In one embodiment, the shared space module 165 may require each accessing party to enter login information for security purposes (e.g., this feature calls for establishing an account for each authorized user). Once each party has access to the shared space 167, the call participants can readily exchange their information electronically using the shared storage space 167. One example of how users can access the shared storage space 167 is shown in FIG. 3.

FIG. 3 illustrates an exemplary web browser window 310 of the access module 145 for accessing the shared storage space 167. In particular, for ease of illustration, FIG. 3 illustrates the shared storage space 167 as seen from the perspective of the caller (located at the first location 110(1)), although the callee (located at the second location 110(2)) may also access a similar screen using the access module 145 of the second processor-based device 140(2). It is noted that the screen 310 shown in FIG. 3 is exemplary in nature, and illustrates one way of accessing the shared storage space 167. In other embodiments, any other suitable manner of accessing the shared storage space 167 may be employed without deviating from the spirit and scope of the present invention.

In the exemplary screen shown in FIG. 3, a portion 315 of the browser window 310 (labeled as “Folders” on the left hand side) includes a history of calls made by the caller for which a shared folder was created. In the illustrated example, the folder portion 315 includes five (5) entries 320(1-5) that were created for the last five (5) calls in which the caller participated. In the illustrated example of FIG. 3, the naming convention for each entry is based on the caller name, callee name, the time the call was placed, and the date the call was made (e.g., caller-callee-time-date). This naming convention allows the call participants to quickly identify the call session that is of interest. Of course, in alternative embodiments, other naming conventions may also be employed.

In one embodiment, each entry 320 in the folder portion 315 may be a hyperlink, which, when selected, shows the contents of that folder. For example, assuming that the first entry 320(1) is associated with the caller's current call (i.e., to the party based at the second location 110(2)), the caller can select this hyperlink to access the shared space 167 between the caller and callee.

The illustrated embodiment of FIG. 3 utilizes a “split screen” format, where the hyperlinks 320(1-5) are shown in the folder portion 315 (left side), and when a particular hyperlink 320 is selected, the contents of its corresponding shared space (e.g., Web space) are shown on the right hand side portion 330 of the browser window 310. The right side portion 330 of the browser window 310 of FIG. 3 illustrates an exemplary screen that the caller may see upon selecting the first entry 320(1) from the folder portion 315. The arrow 332 with dashed lines is utilized herein to graphically denote that the first entry 320(1) corresponds to the Web space contents that are shown on the right portion 330. In the illustrated embodiment, the right portion 330 of the window 310 illustrates the various documents that are shared between the caller and callee. For example, a window 335 illustrates the callee is sharing a text document 340(1), a graphics document 340(2), and an audio file 340(3) with the caller, while a window 350 illustrates that the document(s) (e.g., a video file 360) that the caller is sharing with the callee. The documents 340(1-3) provided by the callee may be accessed by the caller by downloading them to a local storage space of the processor-based device 140(1), or, alternatively, by remotely opening them without downloading copies to the processor-based device 140(1).

The caller may share electronic documents with the callee in a variety of ways. In one embodiment, the access module 145 may allow the caller to use a drag-and-drop method, where the user selects the desired document(s) to share, and drags and drops them in the browser window 350, for example. As will be appreciated by those skilled in the art having the benefit of this disclosure, an applet (or another software application) associated with the access module 145 may be employed to allow the caller to use the drag-and-drop feature. The applet may be integrated with the access module 145, in one embodiment. In another example, instead of utilizing the “drag and drop” feature, the caller may upload the electronic document 360 to the server 150 using a file transfer protocol by providing an appropriate destination address of the shared storage space 167 or of the server 150. Similarly, other desirable ways of transferring the electronic document(s) 360 to the shared storage space 167 may also be employed without deviating from the spirit and scope of the present invention.

Referring again to FIG. 2, the shared space module 165 determines (at 252) if it is desirable to retain the shared storage space 167 upon the termination of the call. Depending on the implementation, in one embodiment, the module 165 may maintain the shared space 167 (at 255) even after the termination of the call so that the caller can revisit the shared space 167 at a later time to view previously shared documents. In an alternative embodiment, the shared space module 165 may remove (at 260) the contents stored in the shared space 167 after the termination of the call.

As described, in accordance with one or more embodiments of the present invention, parties participating in a telephone call can readily exchange documents via the shared storage space 167. In one embodiment, the shared storage space 167 is created based on information collected from the call that is placed by the calling party. The information may, for example, include the name or number of the calling party and called party or parties (in the case of a teleconference call). Once the shared storage space 167 for the communicating parties is established, each party may share electronic data, in the form of documents or files, with others call participants.

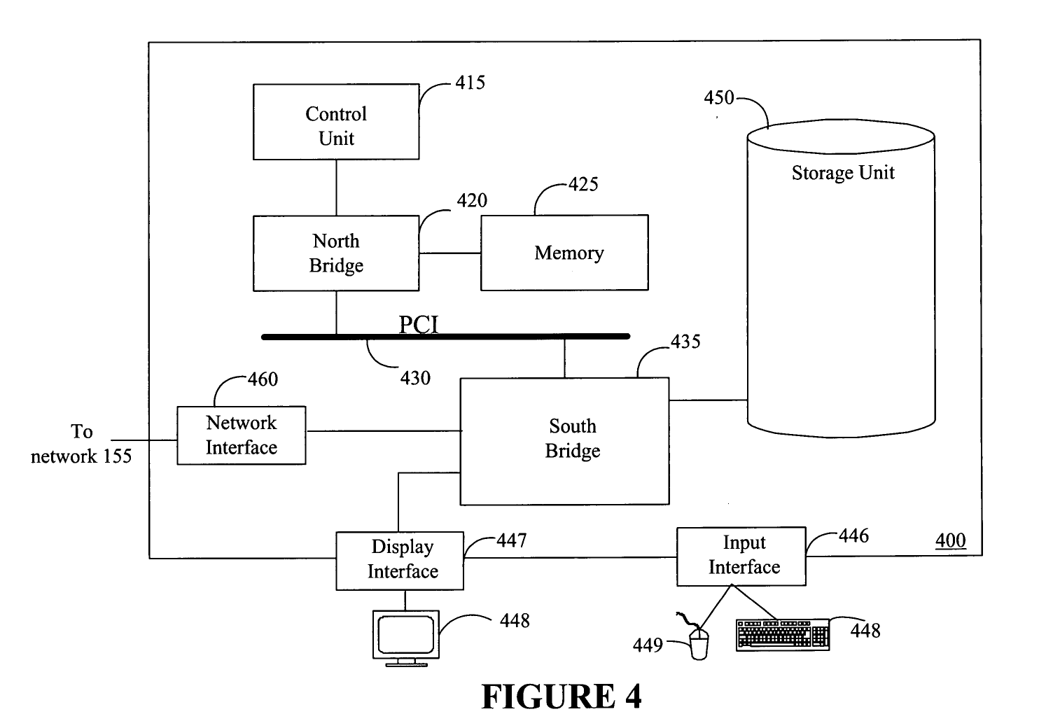

Referring now to FIG. 4, a stylized block diagram of a device 400 that may be implemented in the communications system 100 of FIG. 1 is illustrated, in accordance with one embodiment of the present invention. That is, the device 400 may represent one embodiment of the processor-based device 140(1) and/or the server 150. The device 400 comprises a control unit 415, which in one embodiment may be a processor that is capable of interfacing with a north bridge 420. The north bridge 420 provides memory management functions for a memory 425, as well as serves as a bridge to a peripheral component interconnect (PCI) bus 430. In the illustrated embodiment, the system 400 includes a south bridge 435 coupled to the PCI bus 430.

A storage unit 450 is coupled to the south bridge 435. The software installed in the storage unit 450 may depend on the features to be performed by the device 400. For example, if the device 400 is implemented as the processor-based device 140 of FIG. 1, then the storage unit 450 may include at least the access module 145. If the device 400 is implemented as the server 150 of the FIG. 1, then the storage unit 650 may include at least the modules 160, 165. The modules 145, 160, 165 may be executable by the control unit 415. Although not shown, it should be appreciated that in one embodiment an operating system, such as Windows®, Disk Operating System®, Unix®, OS/2®, Linux®, MAC OS®, or the like, may be stored on the storage unit 450 and executable by the control unit 415. The storage unit 450 may also include device drivers for the various hardware components of the system 400.

In the illustrated embodiment, the system 400 includes a display interface 447 that is coupled to the south bridge 435. The system 400 may display information on a display device 448 via the display interface 447. The south bridge 435 of the system 400 may include a controller (not shown) to allow a user to input information using an input device, such as a keyboard 448 and/or a mouse 449, through an input interface 446.

The south bridge 435 of the system 400, in the illustrated embodiment, is coupled to a network interface 460, which may be adapted to receive, for example, a local area network card. In an alternative embodiment, the network interface 460 may be a Universal Serial Bus interface or an interface for wireless communications. The system 400 communicates with other devices coupled to the network 155 through the network interface 460. Although not shown, associated with the network interface 460 may be a network protocol stack, with one example being a UDP/IP (User Datagram Protocol/Internet Protocol) stack. UDP is described in RFC 768, entitled “User Datagram Protocol,” dated August 1980. In one embodiment, both inbound and outbound packets may be passed through the network interface 460 and the network protocol stack.

It should be appreciated that the configuration of the device 400 of FIG. 4 is exemplary in nature and that, in other embodiments the device 400 may include fewer, additional, or different components without deviating from the spirit and scope of the present invention. For example, in an alternative embodiment, the device 400 may not include a north bridge 420 or a south bridge 435, or may include only one of the two bridges 420, 435, or may combine the functionality of the two bridges 420, 435. As another example, in one embodiment, the system 400 may include more than one control unit 415. Similarly, other configurations may be employed consistent with the spirit and scope of the present invention.

The various system layers, routines, or modules may be executable control units (such as control unit 415 (see FIG. 4)). The control unit 415 may include a microprocessor, a microcontroller, a digital signal processor, a processor card (including one or more microprocessors or controllers), or other control or computing devices. The storage devices 450 referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices 450. The instructions when executed by a respective control unit 415 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
receiving information associated with a telephone call involving a first party and a second party;
allocating a storage space that is accessible by at least one of the first party and the second party based on at least a portion of the received information; and
allowing at least one of the first party and second party to provide electronic information intended for the other party using the storage space.

2. The method of claim 1, wherein allocating the storage space comprises allocating the storage space associated with a server on the Internet, and wherein the storage space is accessible by both the first party and the second party.

3. The method of claim 2, wherein receiving the information comprises receiving at least one of information associated with a name of a calling party, information associated with a name of a called party, information associated with a telephone number from which the telephone call originates, information associated with a telephone number to which the telephone call is made, information associated with a time of the telephone call, and information associated with a date of the telephone call.

4. The method of claim 1, wherein allocating the storage space comprises defining an electronic folder for each telephone call made by at least one of the first party and the second party, wherein each electronic folder is adapted to store electronic information that is exchanged by the first and second party during that call.

5. The method of claim 1, wherein the act of allowing comprises allowing the second party to provide electronic information intended for the first party using the storage space.

6. The method of claim 1, further comprising determining if at least one of the first party and second party is authorized to access the storage space and wherein the act of allocating the storage space comprises allocating the storage space based on determining that at least one of the first party and second party is authorized to access the storage space.

7. The method of claim 1, wherein the act of determining comprises determining if at least one of the first party and the second party is on a call block list and determining if at least one of the first party and the second party is a subscriber.

8. The method of claim 1, wherein the telephone call is managed by a service provider, and wherein receiving the information comprises at least one of receiving the information provided by the service provider and accessing caller identification information associated with the telephone call.

9. The method of claim 1, wherein the telephone call is a conference call, and wherein the act of receiving comprises receiving the information associated with the conference call involving the first party, the second party, and a third party.

10. The method of claim 1, wherein the act of allocating comprises creating an electronic folder associated with each of the first party and the second party and further associating the two electronic folders with each other.

11. The method of claim 1, wherein the act of allowing comprises allowing at least one of the parties to provide at least one of a text file, a graphics file, a video file, an audio file, and a multimedia file.

12. The method of claim 1, wherein the storage space is associated with a remotely located server, and wherein the act of allowing comprises allowing the first party to upload an electronic file to the storage space by at least one of dragging and dropping the electronic file in a selected window and transferring the electronic file using a desirable file transfer protocol.

13. An article comprising one or more machine-readable storage media containing instructions that when executed enable a processor to:
receive information associated with a telephone call involving a first party and a second party;
allocate a storage space that is accessible by at least one of the first party and the second party based on at least a portion of the received information; and
allow at least the first party to provide electronic information intended for the second party using the storage space.

14. The article of claim 13, wherein the instructions when executed enable the processor to define an electronic folder for each telephone call made by at least one of the first party and the second party, wherein each electronic folder is adapted to store electronic information that is exchanged by the first and second party during that call.

15. The article of claim 13, wherein the instructions when executed enable the processor to further determine if at least one of the first party and second party is authorized to access the storage space and to allocate the storage space based on determining that at least one of the first party and second party is authorized to access the storage space.

16. The article of claim 13, wherein the instructions when executed enable the processor to determine if at least one of the first party and the second party is on a call block list and determining if at least one of the first party and the second party is a subscriber.

17. The article of claim 13, wherein the telephone call is a conference call, and wherein the instructions when executed enable the processor to receive the information associated with the conference call involving the first party, the second party, and a third party.

18. The article of claim 13, wherein the instructions when executed enable the processor to create an electronic folder associated with each of the first party and the second party and further linking the two electronic folders.

19. The article of claim 13, wherein the instructions when executed enable the processor to receive at least one of information associated with a name of a calling party, information associated with a name of a called party, information associated with a telephone number from which the telephone call originates, information associated with a telephone number to which the telephone call is made, information associated with a time of the telephone call, and information associated with a date of the telephone call.

20. An apparatus, comprising:
a storage unit; and
a control unit communicatively coupled to the storage unit, the control unit adapted to:
receive information associated with a telephone call involving a first party and a second party;
allocate a storage space in the storage unit that is accessible by at least one of the first party and the second party based on at least a portion of the received information; and
allow at least the first party to provide electronic information intended for the second party using the storage space.

21. The apparatus of claim 20, wherein the control unit is adapted to allocate the storage space that is accessible to both the first party and the second party.

22. The apparatus of claim 20, wherein the control unit is adapted to define an electronic folder for each telephone call made by at least one of the first party and the second party, wherein each electronic folder is adapted to store electronic information that is exchanged by the first and second party during that call.

23. The apparatus of claim 20, wherein the control unit is adapted to further determine if at least one of the first party and second party is authorized to access the storage space and to allocate the storage space based on determining that at least one of the first party and second party is authorized to the access storage space.

24. The apparatus of claim 20, wherein the control unit is adapted to determine if at least one of the first party and the second party is on a call block list and determining if at least one of the first party and the second party is a subscriber.

25. The apparatus of claim 20, wherein the telephone call is a conference call, and wherein the control unit is adapted to receive the information associated with the conference call involving the first party, the second party, and a third party.

26. The apparatus of claim 20, wherein the control unit is adapted to create an electronic folder associated with each of the first party and the second party and further linking the two electronic folders.

27. The apparatus of claim 20, wherein the control unit is adapted to receive at least one of information associated with a name of a calling party, information associated with a name of a called party, information associated with a telephone number from which the telephone call originates, information associated with a telephone number to which the telephone call is made, information associated with a time of the telephone call, and information associated with a date of the telephone call.

28. A system, comprising:
a first processor-based device; and
a second processor-based device communicatively coupled to the first processor-based device, the second processor-based device adapted to:
receive information associated with a telephone call involving a first party and a second party;
allocate a storage space that is accessible by at least one of the first party and the second party based on at least a portion of the received information; and
allow at least the first party to at least one of provide and receive electronic information using the first-processor device to and from the storage space.

29. The system of claim 28, wherein the first processor-based device and the second processor-based device are communicatively coupled over a network.

30. The system of claim 29, wherein the network is the Internet and wherein the storage space is allocated on a storage unit that is remotely located from the second processor-based device.

31. A method, comprising:
accessing a storage space that is allocated based on information associated with a telephone call involving a first party and a second party, wherein the storage space is accessible to at least the first party and second party; and
accessing electronic information from the storage space, wherein the electronic information is provided by at least one of the first party and second party.

32. The method of claim 31, wherein accessing the storage space comprises gaining access to a sever by providing login information.

33. The method of claim 31, wherein accessing the storage space comprises accessing an electronic folder to which both the first party and the second party have access.
